(19) United States
(12) Patent Application Publication
(10) Pub. No.: US 2026/0112594 A1
(43) Pub. Date: Apr. 23, 2026

(54) Ion Routing Device

(71) Applicant: THERMO FISHER SCIENTIFIC (BREMEN) GMBH, Bremen (DE)

(72) Inventors: Mikhail Skoblin, Dolgoprudny (RU); Dmitry Grinfield, Bremen (DE); Alexander Makarov, Bremen (DE); Dmitry Strelnikov, Bremen (DE)

(73) Assignee: THERMO FISHER SCIENTIFIC (BREMEN) GMBH, Bremen (DE)

(21) Appl. No.: 19/354,635

(22) Filed: Oct. 9, 2025

(30) Foreign Application Priority Data
Oct. 18, 2024 (GB) GB2415335.5

(51) Int. Cl. H01J 49/06

(52) U.S. Cl. CPC H01J 49/063

(57) ABSTRACT

There is provided an ion routing device comprising at least three branches that meet at a junction. Each branch defines an ion path through the ion routing device, the ion path through each branch defining a longitudinal axis of the branch. Each branch comprises longitudinally-extending electrodes, and the longitudinally-extending electrodes of each branch are electrically isolated from the longitudinally-extending electrodes of adjacent branches. A controller is configured to control passage of ions through the ion routing device, wherein the controller is configured to provide a RF electrical signal to the longitudinally-extending electrodes of each branch and to apply a DC bias to each RF electrical signal that differs between the longitudinally-extending electrodes of at least two of the adjacent branches.

### FIELD OF INVENTION

This disclosure relates to an ion routing device, more specifically, to an ion routing device that may be used for manipulation and transportation of ions in a mass-spectrometer.

### BACKGROUND OF THE INVENTION

A typical mass spectrometer comprises an ion source, ion processing devices and an ion mass analyzer/detector. The ion source generates a mixture of ionized species from an analyte that passes through the ion processing devices and on to the ion mass analyzer/detector. The ion processing devices may include a mass filter, a mass separator, an ion storage device and a reaction cell. The ion mass analyzer/detector is used to detect the number of incident ions as a function of the mass of the ions.

In most common mass spectrometer architectures, the ion processing devices are connected sequentially, as illustrated in FIG. 1A. Such a sequential architecture allows the ions to propagate from the source to the final detector in a single path only. This constrains the mass spectrometer to have only one ion source and only one dead-end ion detector. Another disadvantage of a sequential architecture is that the ions must pass through all ion processing devices even in operation modes which do not benefit from such passage. For example, a mass filter and an ion fragmentation device are only functional during MS2 scans but ions must pass through these devices, though inactivated, during acquisition of panoramic MS1 spectra. The sequential architecture suffers, therefore, from unnecessary ion losses and time delays resulting, correspondingly, in sensitivity deterioration and longer processing times.

These issues worsen with the mass spectrometer's complexity and versatility. For instance, a mass spectrometer may be provided with several different ion processing devices, such as cells for collisional fragmentation, electron-based fragmentation (ExD), UV fragmentation, etc. Such mass spectrometers might suffer from additional delays if the ions had to pass through all ion processing devices, including inactive ones, if arranged in a sequential architecture.

Some ion processing devices, like gas-phase reactive cells, ExD cells, and UV fragmentation cells, are relatively slow and take up to 100 ms time to process an ion population. If such methods of ion processing are involved in a mass-spectrometric scan, a mass spectrometer with sequential architecture is eventually blocked for other faster scans, e.g. obtaining panoramic MS1 spectra or MS2 spectra with collisional fragmentation which take only a few milliseconds to perform.

Flexible ion routing has been used to address these drawbacks. To this end, mass spectrometers can be equipped with ion routing devices capable of selectively redirecting the ionic flux in one of two or more arbitrary directions. A mass spectrometer with such a branched architecture is illustrated in FIG. 1B. Ion processing device 1 and ion processing device 2 of FIG. 1B may be by-passed by sending incoming ions directly to the ion mass analyzer/detector for a fast MS1 spectrum acquisition. For obtaining MS2 spectra, an ion routing device may first direct ions to either ion processing device 1 or ion processing device 2 for processing and, when processing is complete, the ion routing device may direct the processed ions to the ion mass analyzer/detector. When an ion population is being processed in, e.g., ion processing device 1, the mass-spectrometer is capable of concurrent acquisition of further MS1 spectra or further MS2 spectra using ion processing device 2.

High-vacuum transporting devices (in which the ions move with essentially no gas collisions and at velocities substantially exceeding thermal velocities) may act as an ion routing device that selectively directs ions along alternative ion paths using a switchable deflector. This approach is inconvenient, however, for ion transfer between gas-filled ion processing devices, for which the low-energy ion transfer in gas-filled ion guides is preferable.

There are, nevertheless, prior art mass spectrometers with ion routing devices comprising gas-filled RF multipoles and RF carpets capable of selective ion transfer between different paths. U.S. Pat. No. 9,812,311 describes an ion routing device with two parallel planar RF ion carpets separated by a gap. The carpets form tracks along which ions may move while being constrained in the volume between the carpets. Segmented DC electrodes are positioned on both sides of the tracks on the same parallel substrates that host the RF carpets. The DC electrodes are biased with retarding voltages (e.g. positive voltage for processing cations) which keep the ions on the RF tracks and also generate a field gradient to propel the ions along the tracks. U.S. Patent Application No. 2021/0364467 and U.S. Pat. No. 11,119,069 describe similar arrangements, but that utilize travelling waves for ion propulsion along the tracks between ion carpets.

U.S. Pat. No. 7,420,161 describes a Y-shaped multipole which may direct ions to one of two RF quadrupole branches. Its advantage over ion routing devices with RF carpets consists in better containment of ions in quadrupolar fields. However, it suffers a drawback in that switching between the two branches requires changing the RF phase on some electrodes by 180 degrees, which is a relatively slow process and requires complicated electronic supply.

U.S. Pat. No. 7,358,488 describes a cross-shaped structure of four branches that meet each other at right angles, as shown schematically in FIG. 2. The four branches comprise RF electrodes which generate four RF multipoles (quadrupoles or octapoles). The RF electrodes are labelled “A”. A pair of blocking electrodes prevent ions escaping the junction region where the RF field is weaker (one of which is shown in FIG. 2, labelled as “B”). In the quadrupole variant, eight L-shaped electrodes are fed with RF in two opposite polarities, which generate a continuous X-shaped valley of RF ponderomotive potential, in which ions may propagate in either of the four branches. A desired ion path is selected through application of axial field gradients along the two required branches and application of blocking DC potentials to the other two branches. Such a design suffers from a problem of significant ion losses and delays caused by insufficient extraction field at the junction region, especially when a 90-degree turn is required.

### SUMMARY

According to a first aspect, there is provided an ion routing device comprising at least three branches that meet at a junction. Each branch defines an ion path through the ion routing device, the ion path through each branch defining a longitudinal axis of the branch. Each branch comprises longitudinally-extending electrodes, and the longitudinally-extending electrodes of each branch are electrically isolated from the longitudinally-extending electrodes of adjacent branches. The ion routing device also comprises a controller configured to control passage of ions through the ion routing device. The controller is configured to provide a RF electrical signal to the longitudinally-extending electrodes of each branch and to apply a DC bias to each RF electrical signal that differs between the longitudinally-extending electrodes of at least two of the adjacent branches.

The application of different DC biases to the branches allows the route of the ion through the ion routing device to be selected as ions may be attracted to pass though some branches and repelled so as not to pass through other branches. The arrangement speeds up and minimizes losses of the ions during their passage through the ion routing device. The geometry may be optimized to minimize along the entire ion trajectory the quadrupolar component of the DC field which usually leads to increased losses for higher masses.

The advantage of increased speed of ion transfer is particularly beneficial during ion transfers that see the ions pass through a 90-degree bend between branches. Also, the arrangement is highly adaptable for use in a very wide range of instrument configurations. The arrangement allows lossless ion transfer (or very low loss ion transfer) between different ion processing devices (IPDs) and/or more than one mass source or mass analyzer. The different IPDs, mass source(s) and mass analyzer(s) may be arranged to receive ions from different branches of the ion routing device. This arrangement is highly advantageous in mass spectrometers that combine fast and slow IPDs or analyzers, as ions may be selectively routed to reduce time delays by enabling parallel functioning of IPDs. As a result, the overall speed and sensitivity of a mass spectrometer is improved.

The controller may be configured to provide an in-phase RF electrical signal to the longitudinally-extending electrodes of each branch such that electrical fields generated in each branch are in-phase with each other.

For example, the controller may be configured to control the passage of ions through the ion routing device from an input branch to an output branch of the at least three branches, thereby leaving at least one unused branch, by (i) providing the RF electrical signal to the longitudinally-extending electrodes of the input branch with a first DC bias, (ii) providing the RF electrical signal to the longitudinally-extending electrodes of the output branch with a second DC bias that is lower in magnitude than the first DC bias, and (iii) providing the RF electrical signal to the longitudinally-extending electrodes of the at least one unused branch with a third DC bias that is higher in magnitude than the first DC bias.

The ion routing device may comprise a RF power supply for providing the RF electrical signal. The RF power supply may be configured to provide the RF electrical signal to the primary coil of a transformer that further comprises a secondary coil for each of the at least three branches. The ends of each secondary coil may be connected to at least one opposed pair of longitudinally-extending electrodes of the respective branch. The centre point of each secondary coil is connected to a DC power supply configured to provide the DC bias to the RF electrical signal. This provides a simple arrangement for providing different DC biases to the different branches.

The ion routing device may comprise a pair of central electrodes positioned on opposite sides of the junction and the controller is further configured to provide a DC electrical signal to the pair of central electrodes. Conveniently, this allows the central electrodes to be biased to counteract ions escaping from the junction of the ion routing device.

Optionally, each branch comprises four longitudinally-extending electrodes arranged to form two pairs of longitudinally-extending electrodes, each pair of longitudinally-extending electrodes positioned on opposite sides of the ion path thereby forming an opposed pair of the at least one opposed pair of longitudinally-extending electrodes. Such an arrangement results in a quadrupolar trapping field that traps the ions within the space between the four longitudinally-extending electrodes.

The at least three branches may meet at the junction such that the size of the ion paths (e.g. cross-sectional area of the ion path) through each branch are maintained. For example, the branches and the junction may be free of obstructions that would impinge on an ion beam passing through the ion routing device. The ion paths may extend through the junction without optical apertures configured to restrict the size of an ion beam travelling along the ion paths from one branch to another branch. Aperture plates or apertured separating walls may be omitted from the junction where the branches meet.

The ends of the longitudinally-extending electrodes of adjacent branches that meet at the junction may be shaped to form a mitred corner. This results in better control of the field shape at the junction.

In currently-preferred embodiments, each branch further comprises transversely-extending electrodes, and the controller is further configured to provide a DC electrical signal to the transversely-extending electrodes of each branch. The resulting DC field helps direct the passage of the ions through the ion routing device in the desired direction. For each branch, the controller may be configured to provide the DC electrical signal via a resistor chain such that the transversely-extending electrodes are provided with an electrical signal of varying DC magnitude. The transversely-extending electrodes of each branch may form a longitudinally-extending series of electrodes, and the resistor chain may be configured such that the DC magnitude of the DC electrical signal provided to each transversely-extending electrode varies progressively along the series of electrodes. The DC magnitude may vary linearly along the series of electrodes, or may vary according to a monotonic function.

The controller may be further configured to apply traveling-wave voltage signals to the electrodes. The traveling-wave voltage signals may urge ions through the ion routing device. The controller may be configured to apply dynamic or variable DC voltages, amplitude-modulated RF waveforms, or frequency-modulated RF waveforms in sequence to the electrodes. This may create electrical potential wells that migrate from one end of a branch to the other end of a branch. The moving potential wells can transport ions through the ion routing device.

Optionally, the longitudinally-extending electrodes and the transversely-extending electrodes are formed on printed circuit boards. This manufacturing method is particularly well suited to forming the arrangements of electrodes described herein. The longitudinally-extending electrodes may be attached to the printed circuit boards, for example by soldering. All longitudinally-extending electrodes to be attached to one printed circuit board may be formed as a single piece and then attached to the printed circuit board, before the gaps between the individual longitudinally-extending electrodes are formed, for example by wire etching. The transversely-extending electrodes may be formed directly on the printed circuit boards, for example by etching. The outer sides of the printed circuit boards may be provided with electrical contacts that connect to the longitudinally-extending electrodes and the transversely-extending electrodes. The outer sides of the printed circuit boards may also be provided with the resistor chain used to supply the DC electrical signal to the transversely-extending electrodes.

According to a second aspect, there is provided a method of selectively directing ions through an ion routing device. The ion routing device comprises at least three branches that meet at a junction. Each branch defines an ion path through the ion routing device with the ion path through each branch defining a longitudinal axis of the branch. Each branch comprises longitudinally-extending electrodes. The longitudinally-extending electrodes of each branch are electrically isolated from the longitudinally-extending electrodes of adjacent branches. The method comprises providing a RF electrical signal to each of the longitudinally-extending electrodes of each branch, and applying a DC bias to each RF electrical signal that differs between the longitudinally-extending electrodes of at least two of the adjacent branches.

An in-phase RF electrical signal may be provided to the longitudinally-extending electrodes of each branch such that electrical fields generated in each branch are in-phase with each other.

The method may comprise selectively directing ions through the ion routing device from an input branch to an output branch of the at least three branches, thereby leaving at least one unused branch. The RF electrical signal may be provided to the longitudinally-extending electrodes of the input branch with a first DC bias. The RF electrical signal may be provided to the longitudinally-extending electrodes of the output branch with a second DC bias that is lower in magnitude than the first DC bias. The RF electrical signal may be provided to the longitudinally-extending electrodes of the at least one unused branch with a third DC bias that is higher in magnitude than the first DC bias.

Optionally, the method comprises using a RF power supply to provide the RF electrical signal to the primary coil of a transformer that further comprises a secondary coil for each of the at least three branches. The ends of each secondary coil may be connected to at least one opposed pair of longitudinally-extending electrodes of the respective branch. The centre point of each secondary coil may be connected to a DC power supply configured to provide the DC bias to the RF electrical signal. Each branch may comprise four longitudinally-extending electrodes arranged to form two pairs of longitudinally-extending electrodes. Each pair of longitudinally-extending electrodes may be positioned on opposite sides of the ion path thereby forming an opposed pair of the at least one opposed pair of longitudinally-extending electrodes. Each branch may comprise four longitudinally-extending electrodes arranged to form two pairs of longitudinally-extending electrodes. Each pair of longitudinally-extending electrodes may be positioned on opposite sides of the ion path thereby forming an opposed pair of the at least one opposed pair of longitudinally-extending electrodes.

The ends of the longitudinally-extending electrodes of adjacent branches that meet at the junction may be shaped to form a mitred corner.

The method may further comprise providing a DC electrical signal to a pair of central electrodes positioned on opposite sides of the junction.

Each branch may further comprise transversely-extending electrodes, and the method may further comprise providing a DC electrical signal to the transversely-extending electrodes of each branch. For each branch, the DC electrical signal may be provided via a resistor chain such that the transversely-extending electrodes are provided with an electrical signal of varying DC magnitude. The transversely-extending electrodes of each branch may form a longitudinally-extending series of electrodes such that the DC magnitude of the DC electrical signal provided to each transversely-extending electrode varies progressively along the series of electrodes. The resistor chain of each branch may be configured such that the DC magnitude of the DC electrical signal provided to each transversely-extending electrode varies linearly along the series of electrodes.

The longitudinally-extending electrodes and the transversely-extending electrodes may be formed on printed circuit boards. The longitudinally-extending electrodes may be attached to the printed circuit boards, and the transversely-extending electrodes may be formed directly on the printed circuit boards, for example by etching. The outer sides of the printed circuit boards may be provided with electrical contacts that connect to the longitudinally-extending electrodes and the transversely-extending electrodes. The outer sides of the printed circuit boards may be provided with the resistor chain used to supply the DC electrical signal to the transversely-extending electrodes.

### LIST OF FIGURES

In order that the invention can be more readily understood, reference will now be made by way of example only, to the accompanying drawings in which:

FIG. 1A is a schematic representation of a prior art mass spectrometer with a sequential arrangement of cells and FIG. 1B is a schematic representation of a prior art mass spectrometer with a non-sequential arrangement of cells enabled by an ion routing device;

FIG. 2 is a schematic representation of a prior art ion routing device;

FIG. 3A is a schematic representation of an embodiment of an ion routing device, and FIG. 3B is a schematic representation of an alternative biasing arrangement of the ion routing device of FIG. 3A;

FIG. 4A is a schematic representation of a power supply arrangement for supplying electrical signals to RF electrodes of an ion routing device like the ion routing device of FIG. 3A, FIG. 4B is a schematic representation of an alternative power supply arrangement, and FIG. 4C is a schematic representation of a power supply arrangement for supplying electrical signals to DC electrodes of an ion routing device like the ion routing device of FIG. 3A;

FIG. 5 is a schematic representation of an embodiment of an ion routing device implemented using printed circuit boards;

FIGS. 6A and 6B show RF-pseudopotentials and combined DC field seen in an ion routing device like that shown in FIG. 5 for ion transfer straight through the ion routing device and with a 90 degree turn through the ion routing device respectively;

FIG. 7 is a graph showing ion transfer efficiency for the straight through and 90 degree turn ion transfers of FIGS. 6A and 6B;

FIG. 8 is a schematic representation of a mass spectrometer with MS2 capability that uses various fragmentation methods as implemented using an embodiment of an ion routing device;

FIG. 9 is a schematic representation of a mass spectrometer with MS3 capability implemented using an embodiment of an ion routing device;

FIG. 10 is a schematic representation of another mass spectrometer with MS2 capability implemented using an embodiment of an ion routing device; and

FIGS. 11A and 11B are schematic representations of mass spectrometers including two ion routing devices.

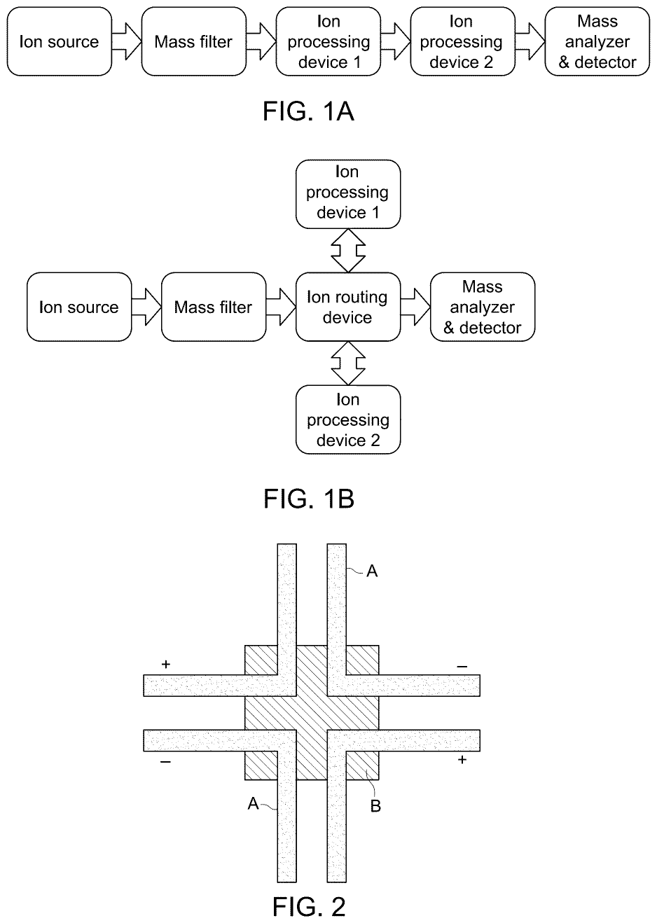

### DETAILED DESCRIPTION

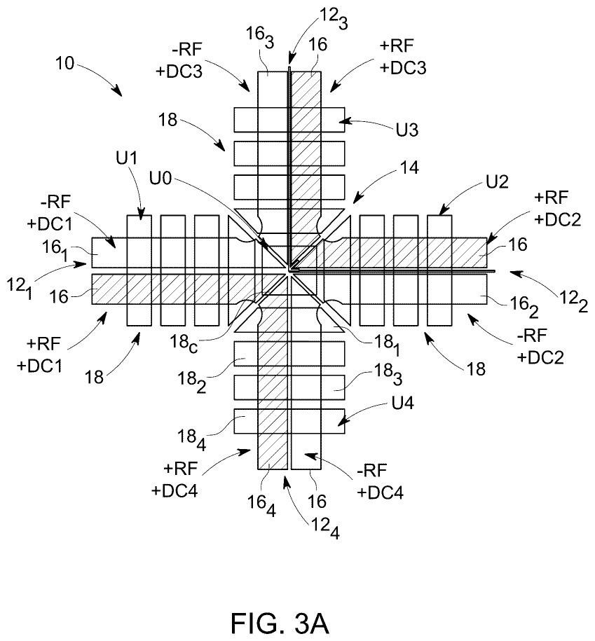

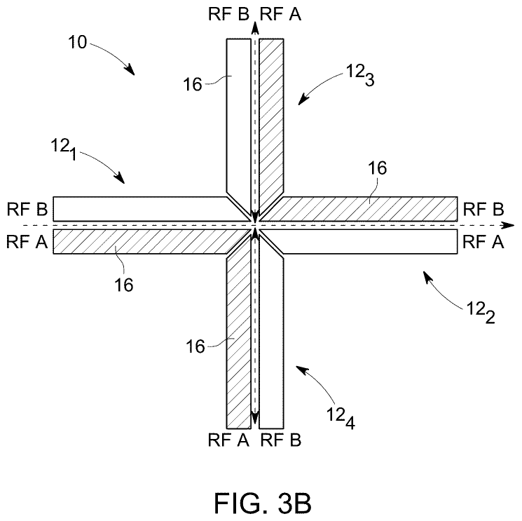

An embodiment of an ion routing device 10 according to the present invention is shown in FIG. 3A. The ion routing device 10 comprises four branches 12₁ to 12₄ₗ that comprise respective ion guides. The branches 12₁ to 12₄ meet at a junction 14. Each branch 12₁ to 12₄ comprises four RF electrodes 16: the plan view of FIG. 3A shows only the upper half of the ion routing device 10, i.e. just the upper pair of RF electrodes 16 of each branch 12₁ to 12₄. As can be seen, the RF electrodes 16 are longitudinally-extending electrodes. To demonstrate the arrangement of what is referred to as “adjacent RF electrodes” 16, i.e. adjacent electrodes 16 that end next to each other at the junction 14, the RF electrodes of one such pair are labelled as 16₁ and 16₂.

RF waveforms are applied to the RF electrodes 16 to produce an electrical field that constrains ions to move along the central volume of each branch 12₁ to 12₄ within the four respective sets of RF electrodes 16. Also, DC offsets may be applied to the RF electrodes 16. The magnitude of the DC offsets applied to the RF electrodes 16 of different branches 12₁ to 12₄ may be varied relative to each other to allow ions to be directed from one particular branch 12₁ to 12₄ to another particular branch 12₁ to 12_{4.}

The RF waveforms may be applied to the RF electrodes 16 in the polarities shown in FIG. 3A as +RF and −RF. Using RF electrodes 16₁ and 16₂ as examples, adjacent RF electrodes like 16₁ and 16₃ have the same RF polarities (and hence phase), −RF in this case. The corresponding RF electrodes 16 of the lower half (not shown in FIG. 3A) of the ion routing device 10 are supplied with RF waveforms of opposite polarities, i.e. the lower RF electrodes corresponding to 16₁ and 16₃ have a polarity of +RF. In this way, the desired electrical field is produced that keeps the ions in the space between the RF electrodes 16.

FIG. 3A shows that adjacent RF electrodes, like RF electrodes 16₁ and 16₃, are electrically separated from each other by small gaps at the junction 14 (e.g. 0.5 mm wide). The ends of adjacent electrodes (like electrodes 16₁ and 16₃) can be shaped to form a mitred corner where they meet at the junction 14. Other shapes may be used, but preferably the electrodes are separated by a gap of constant or substantially constant width. The shape of the gaps may deviate from the straight lines shown in FIG. 3A, for example they could follow any curve. For example, the ends of adjacent RF electrodes 16 can taper from a first width of the electrode 16 distal to the junction 14 to a second width proximal to the junction 14. The adjacent RF electrodes 16 can taper to a point at the junction 14 in some embodiments.

The small gaps provide electrical isolation, thereby allowing DC offsets of differing magnitudes to be applied to the RF electrodes 16 of each branch 12₁ to 12₄, as explained above. All RF electrodes 16 of any particular branch 12₁ to 12₄ are provided with a DC offset having the same magnitude, but this magnitude may vary from branch to branch. The DC offsets applied to the branches 12₁ to 12₄ are denoted as DC1 to DC4 in FIG. 3A.

Hence, each RF electrode 16 has an applied waveform comprising a RF component and a DC offset. For example, RF electrode 16₁ is provided with a RF waveform corresponding to −RF+DC1 whereas RF electrode 16₂ is provided with a RF waveform corresponding to −RF+DC2. As explained above, the RF waveform provides an electrical field that radially constrains ions passing along the branches 12₁ to 12₄, thereby minimising leakage of ions laterally from the branches 12₁ to 12₄ as the ions pass through each branch 12₁ to 12₄. The DC offsets provide an overall attractive or repulsive electrical field to each branch 12₁ to 12₄ relative to the other branches 12₁ to 12₄. The DC offsets are chosen depending on the desired direction of ion transport through the ion routing device 10. For instance, to transport ions (e.g. cations) from branch 12₁ acting as an input branch to branch 12₂ acting as an output branch (i.e. to pass straight through the junction 14), the DC offsets are chosen to provide a relatively weak DC offset to the electrical field in the output branch 12₂ such that DC2≤DC1. This difference in DC offsets ensure ions are attracted from branch 12₁ to branch 12₂. The unused branches 12₃ and 12₄ are blocked by providing larger DC offsets to the electrical fields with DC3>DC1 and DC4>DC1 set on branches 12₃ and 12₄, respectively. The stronger DC offsets of the electrical fields creates a potential difference between branches 12₁ to 12₄ that repels ions away from branches 12₃ and 12₄. As another example, setting DC offsets such that DC3≤DC1, DC2>DC1 and DC4>DC1 will result in potential differences between branches 12₁ to 12₄ that guides the ions injected into branch 12₁ such that the ions turn through 90 degrees and pass into branch 12₃, while blocking the ions from branches 12₂ and 12₄.

FIG. 3B shows an alternative RF phase arrangement placed on the RF electrodes 12 that may be used for straight ion transfers where no beam turning is required (for the sake of simplicity, the DC electrodes 18 are not shown in FIG. 3B). Such an arrangement may provide a better straight ion transfer, e.g. from branch 12₁ to 12₂ as shown in FIG. 3B.

Each branch 12₁ to 12₄ is an open-ended structure where it terminates at the junction 14. In particular, the ion path in the space between the RF electrodes 16 of each branch 12₁ to 12₄ extends into the junction 14 without any obstructions such as a narrowed aperture defined by a separating wall or similar. Hence, the ions have an unnarrowed path from one branch 12₁ to 12₄ to the next branch 12₁ to 12₄ in which the (lateral) size of the ion path is maintained or substantially maintained from one branch 12₁ to 12₄ to the next branch 12₁ to 12₄. In this sense, the junction 14 forms an apertureless interface between the four branches 12₁ to 12₄.

Each branch 12₁ to 12₄ also comprises opposed series of transversely-extending electrodes 18 that are biased with DC-only voltages. Hence, these electrodes 18 are referred to as DC electrodes 18. Each branch 12₁ to 12₄ comprises one series of DC electrodes 18 above the ion path (shown in FIG. 3A) and a second series below the ion path (not shown in FIG. 3A). Each series of DC electrodes 18 extends longitudinally towards the junction 14. There is a pair of common electrodes 18_{c} that sit centrally, one directly above the junction and one directly below the junction 14. The DC electrode 18₁ in each series adjacent the central electrode 18_{c} is provided with angled edges such these DC electrodes 18₁ meet at mitred corners, as best seen by reference to FIG. 3A. Other shapes may be used, but preferably the electrodes are separated by a gap of constant or substantially constant width. The shape of the gaps may vary from the straight lines shown in FIG. 3A. These DC electrodes 18₁ frame the pair central DC electrodes 18.

The DC-only voltages U0 to U4 applied to the DC electrodes 18 are shown in FIG. 3A for the top set of DC electrodes 18. The bottom set of DC electrodes 18 corresponds in shape, size and configuration, and is supplied with the same set of DC-only voltages U0 to U4. The DC electrodes 18 are supplied with DC-only voltages derived from four DC voltages U0 to U4. The DC electrodes 18 generate auxiliary axial electric gradients to the electrical field along each branch 12₁ to 12₄ to drive ions along each branch 12₁ to 12₄. This electric field gradient along each arm 12₁ to 12₄ is realised by connecting the DC electrodes 18 in each series using e.g. a resistor-dividing chain, for example configured to apply a field gradient of 0.001-0.5 V/mm, preferably about 0.15 V/mm.

Hence, the field created by the DC-only voltages U0 to U4 provides a propulsive force to move ions along each branch 12₁ to 12₄ (in either direction), whereas the DC offsets DC1 to DC4 are used to create DC field differences between the different branches 12₁ to 12₄ to steer ions in a desired direction and the RF waveforms ±RF are used to constrain the ions with each branch 12₁ to 12₄ and minimise lateral leakage of ions.

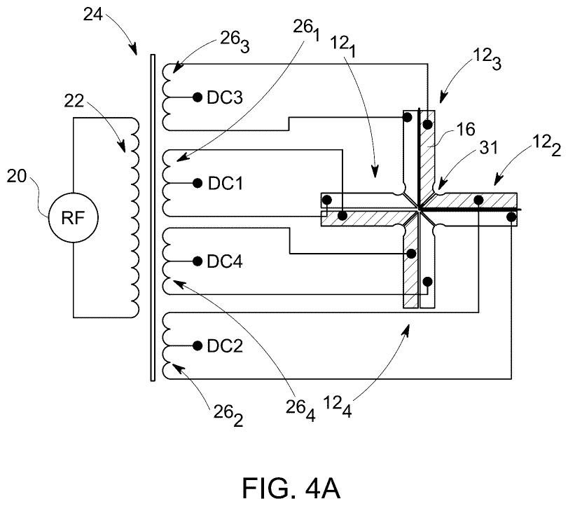

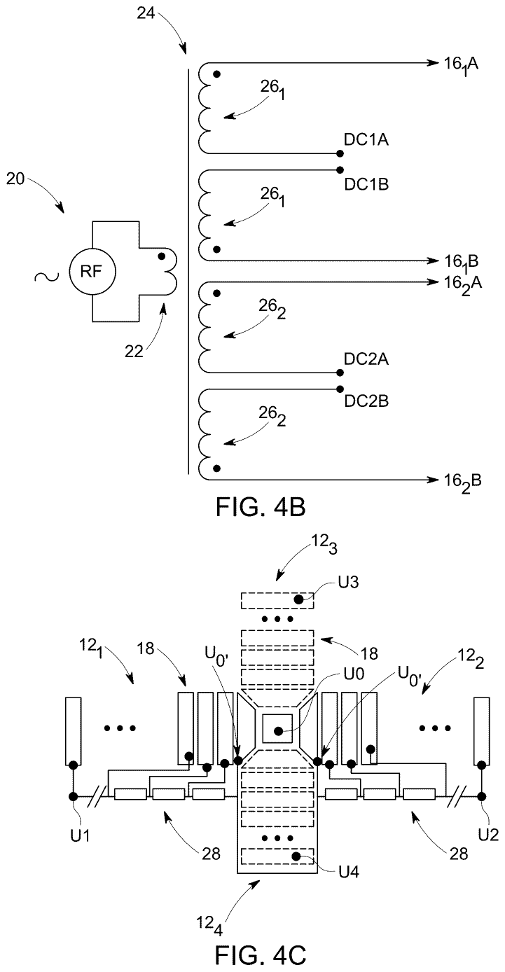

FIG. 4A shows an example arrangement of how the RF waveforms ±RF and DC offsets DC1 to DC4 can be supplied to the RF electrodes 16. FIG. 4A shows a RF power supply 20 that is operable to produce an initial RF waveform that is applied to a primary coil 22 of a transformer 24. The transformer 24 generates phase-matched RF voltages of equal amplitudes to the initial RF waveform in four secondary coils 26₁ to 26₄. Each secondary coil 26₁ to 26₄ is connected across the RF electrodes 16 of a corresponding branch 12₁ to 12₄ such that each branch 12₁ to 12₄ receives the phase-matched RF voltage of equal amplitude to that of the initial RF waveform produced by its secondary coil 26₁ to 26₄. Individually controlled DC voltages are applied to the middle points of each secondary coil 26₁ to 26₄ to provide the DC offsets DC1 to DC4 for the RF electrodes 16 in each branch 12₁ to 12₄.

FIG. 4B shows an alternative example arrangement of how the RF waveforms ±RF and DC offsets DC1 to DC4 can be supplied to the RF electrodes 16. The figure is simplified in that it shows the connections for two branches 12₁ and 12₂. Similar connections are made for branches 12₃ and 12₄.

Like FIG. 4A, FIG. 4B shows a RF power supply 20 that is operable to produce an initial RF waveform that is applied to a primary coil 22 of a transformer 24. The transformer 24 generates phase-matched RF voltages of equal amplitudes to the initial RF waveform in four pairs of secondary coils 26₁ to 26₄. Each secondary coil of the pairs 26₁ to 26₄ is connected between the RF electrode 16 of a corresponding branch 12₁ to 12₄ and an individually controlled DC voltage DC1A, DC1B, DC2A, DC2B, DC3A, DC3B, DC4A and DC4B to provide the DC offsets for the RF electrodes 16 in each branch 12₁ to 12₄. It is possible to apply resolving DC components to one or more branches 12₁ to 12₄, which provide a possibility of mass filtering. For example, DC1A=DC1+resolvingDC, DC1B=DC1−reslovingDC, DC2A=DC2+resolvingDC, DC2B=DC2−resolvingDC, etc. In this case, only ions with a mass to charge ratio m/z satisfying the stability criteria of the Mathieu equation will be able to pass through the branch 12₁ to 12₄ (see, for example, U.S. Pat. No. 2,939,952). Special geometries or fields (asymmetrical rods, multi-frequency RF, etc.) could also be implemented within such guides to improve their performance (see, for example, U.S. Pat. Nos. 7,709,786, 11,282,693, 12,040,173 and 7,633,060). Addition of resolving DC components may be helpful in applications, where only partial transmission of an initial broad m/z range would be beneficial.

FIG. 4C shows an example arrangement of how the DC-only voltages U0 to U4 can be supplied to the DC electrodes 18 of each branch 12₁ to 12₄ using the arrangement of FIG. 4A. The DC electrodes 18 are provided with individually controlled DC voltages defined by voltages U0 to U4. The voltage U0 is applied directly to the pair of electrodes 18_{c} positioned centrally above and below the junction 14. In operation with cations, the DC-only voltage U0 could be higher than all the DC offsets DC1 to DC4 to prevent ion leakage from the top and bottom of the junction 14 of the ion routing device 10.

The DC-only voltages U1 to U4 are applied directly to the DC electrodes 18₁ to 18₄ of each branch 12₁ to 12₄, namely the DC electrodes 18₄ furthest from the junction 14. To reduce the number of individual DC voltage supplies, the other DC electrodes 18₁, to 18₃ in each branch 12₁ to 12₄ are connected through sequential resistor voltage dividers 28 that provide a voltage distribution to the DC electrodes 18₁ to 18₃ in each of the branches 12₁ to 12₄. FIG. 4B shows two resistor voltage dividers 28 for branches 12₁ and 12₂. The corresponding resistor voltage dividers 28 for branches 12₃ and 12₄ are not shown for the sake of clarity. For example, these distributions may be substantially linear such that each DC electrode 18₁ to 18₄ in a series receives a progressively smaller voltage. The DC electrode 18₁ in each branch 12₁ to 12₄ closest to the central electrode 18c receives the same potential U_{0′}. The difference in voltages applied to the DC electrodes 18₁ to 18₃ relative to the central voltages U₀ and U_{0′} creates the field gradient that drives ions along the branches 12₁ to 12₄.

In some embodiments, traveling-wave voltage signals can be applied to the electrodes 18 as an alternative or as an addition to gradient DC fields to urge ions through the ion routing device 10. In various embodiments, dynamic or variable DC voltages, amplitude-modulated RF waveforms, or frequency-modulated RF waveforms can be applied in sequence to electrodes 18 to create electrical potential wells that migrate from one end of a branch to the other end of a branch. The moving potential wells can transport ions through the ion routing device 10. (See, for example, U.S. Pat. Nos. 6,812,453, 9,799,503 or 10,692,710).

In some embodiments, the ion routing device 10 of FIG. 3A is gas-filled to a pressure sufficient for ion thermalization on the length of one of the branches 12₁ to 12₄. For example, a branch length of 50 mm would require a gas pressure of N₂ of circa 5×10⁻³ mbar for an ion mass range below 1 kDa and 5×10⁻² mbar for an ion mass range up to 100 kDa. In operation, the ion routing device 10 may be pressurized via a gas inlet capillary and controlled via a feedback loop based on readings of a Pirani gauge (or similar) directly connected to the ion routing device 10.

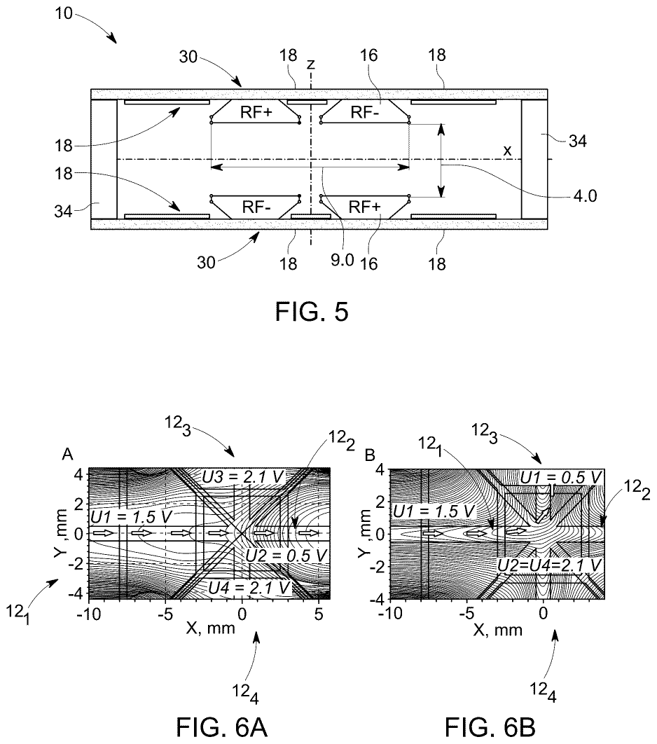

To facilitate propagation of ions through the RF quadrupoles in each branch 12₁ to 12₄, the RF electrodes 16 and the DC electrodes 18 may be implemented on two dielectric substrates 30 as shown in FIG. 5. Each substrate 30 is a printed circuit board (PCB). A pair of RF electrodes 16 is attached to each PCB 30 (e.g. welded, soldered, or glued) which may be a PCB plate. These RF electrodes 16 do not need to have flat or parallel surfaces-they also could have concave or convex shapes, etc. The RF waveform is applied in the alternating polarities ±RF forming a quadrupolar field distribution which constrains ions near the axis along the RF electrodes 16 orthogonal to the plane of the drawing. The DC electrodes 18 are formed directly on the PCBs 30 (e.g. by etching), or are formed externally and attached to the PCBs 30, to generate an axial gradient that propels ions along the axis. The configuration of the RF electrodes 16 and the DC electrodes 18 is optimized to compensate the quadrupolar DC component as taught in U.S. Pat. No. 9,536,722, so that the mass-range of ion stability is maximized. However, other configurations are also possible if a better quality quadrupolar field is required, e.g. RF electrodes could be made hyperbolic, especially when additional mass selection is required within the ion guide 10. Meanwhile, additional PCB electrodes could be added to the sides of RF electrodes 16.

An example of the ion routing device 10 has been numerically simulated using the MASIM 3D software and mechanical design was done in SolidWorks. An ion routing device 10 was modelled as a sandwich of two parallel PCBs 30 with etched DC electrodes 18 and soldered RF electrodes 16. The electrical contacts for RF and DC voltage supplies were implemented on the outer sides of the PCBs 30, as well as the resistor chains 28 that distribute the axial gradient voltage between the DC electrodes 18. All the RF electrodes 16 may be machined from a single piece of metal to form the overall cross shape and then soldered to each PCB 30 in the correct alignment. Then, the central gaps between the RF electrodes 16, the upper surfaces of RF electrodes 16 and the slots at 45 degrees between adjacent electrodes 16 at the junction 14 may be accurately machined and finished by wire erosion technology.

Detailed modeling showed that it is advantageous to narrow the RF electrodes 16 where they meet at the junction 14 (best seen in FIG. 4A). The narrowed portions 31 balance the DC offsets at the centre point of the ion routing device 10 by allowing stronger penetration of the overall DC field into the junction 14 to reach ions in the most effective way. It has been found that without narrowing the RF electrodes 16 in this way, the DC field at the centre point can be uneven, forming either a potential barrier or a potential well at the centre point. Both adversely affect ion transmittance. The quadrupolar field of the resulting branches 12₁ to 12₄ provides the strongest compression of the ion beam at the exits of the branches 12₁ to 12₄ and hence improves ion transfer into subsequent ion processing devices and back. The narrowed portions 31 of the RF electrodes may be provided by cut-outs 31 formed in the corners of the cross shape of RF electrodes 16 where they meet at the junction 14. The cut-outs 31 may be circular, as shown in FIG. 4A, although other shapes may be used.

Spacers 34 between the PCBs 30 also form a gas-tight enclosure to maintain a desirable level of gas pressure inside the ion routing device 10. Also, the spacers 34 may be used for alignment of the ends of each of the branches 12₁ to 12₄ and for alignment with subsequent devices. In the former case, using the spacers 34 to align the fully open ends of the branches 12₁ to 12₄ at the junction 14 helps maintain or substantially maintain the (lateral) size of the ion path from one branch 12₁ to 12₄ to the next branch 12₁ to 12₄. In this sense, the junction 14 forms an apertureless interface between the four branches 12₁ to 12₄. In fact, each branch 12₁ to 12₄ has an internal space with a cross-sectional size defined to either side by the spacers 34 and to the top and bottom by the PCBs 30. This cross-sectional size is the same for each branch 12₁ to 12₄, all of which are open-ended and meet to define large openings between each branch 12₁ to 12₄ relative to the size of the ion path between the RF electrodes 16.

No narrowed apertures defined by separating walls or the like are placed between the branches 12₁ to 12₄ such that the ions have an unnarrowed path from one branch 12₁ to 12₄ to the next branch 12₁ to 12₄.

FIGS. 6A and 6B show distribution of the RF-driven pseudopotential and the combined superimposed DC field in the middle plane of the ion routing device 10 in two modes of operation. FIG. 6A shows an example of straight transmission of ions from branch 12₁ to branch 12₂, whereas FIG. 6B shows an example of transmission of ions with a 90-degree turn from branch 12₁ to branch 12₃.

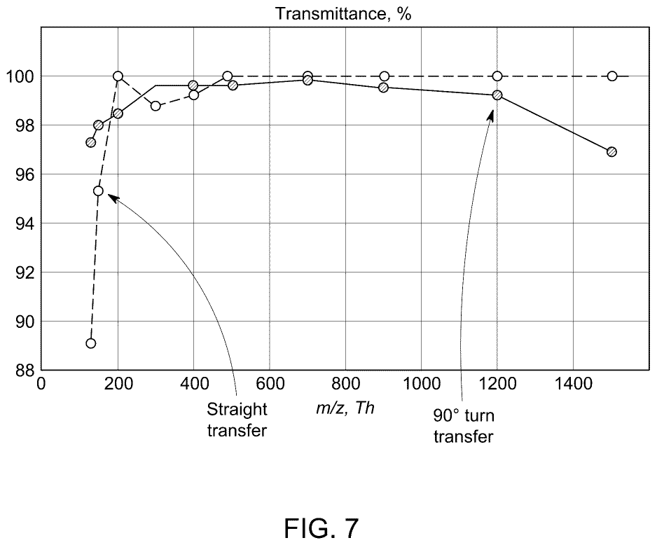

FIG. 7 shows simulated ion transfer efficiency in the two modes of operation shown in FIGS. 6A and 6B. FIG. 7 demonstrates practically 100% lossless transmittance is possible for the straight mode of FIG. 6A for ions with m/z above the low-mass cutoff. FIG. 7 also shows that it is possible to obtain almost 100% transmission over a broad m/z range in the turning mode of FIG. 6B.

Some example arrangements of ion routing devices 10 within mass spectrometers 100 will now be presented.

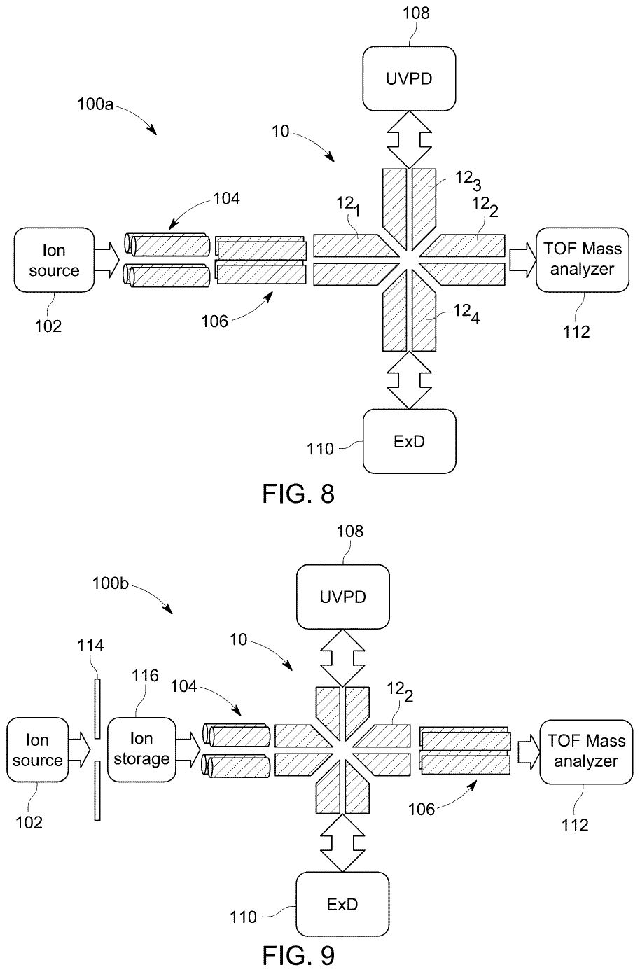

FIG. 8 shows an example of a mass spectrometer 100a which includes an ion source 102, quadrupole mass-filter 104, collision-induced dissociation (CID) cell 106, ion routing device 10, ultra-violet photodissociation (UVPD) cell 108, electron-based-dissociation (ExD) cell 110 (such as an electron collision dissociation cell), and a time-of-flight (TOF) mass analyzer 112. Mass filter 104 is positioned directly after the ion source 102 and allows isolating a particular m/z interval. CID cell 106 follows mass filter 104 and may be activated to fragment selected ions by collisions with gas. The ion routing device 10 contains the same gas as the CID cell 106. The ion routing device 10 receives ions from the CID cell 106 into branch 12₁, and allows selective routing of ions to one of the following devices: the TOF mass analyzer 112 via branch 12₂, the UVPD cell 108 via branch 12₃, or the ExD cell 110 via branch 12₄.

In some modes, the ions are transferred in a straight way through the ion routing device 10 to the TOF mass analyzer 112 via branches 12₁ and 12₂ thereby allowing fast acquisition of MS2 spectra (with repetition rates up to several kHz). In other modes, the ions (fragmented or intact) are diverted to either the UVPD cell 108 via branches 12₁ and 12₃ or to the ExD cell 110 via branches 12₁ and 12₄, where the ions are stored, for example, for 1 ms to 100 ms, and subjected to the corresponding processing. During UVPD and/or ExD processing of stored ions, other ions may be transferred straight through the ion routing device 10 into the TOF mass analyzer 112, which ensures no delays in TOF processing. Upon finishing the UVPD or ExD processing, the processed ions are returned to the ion routing device 10 and transferred to branch 12₂ for onward transmission towards the TOF mass analyzer 112. During this transfer, the ion routing device's input branch 12₁ is kept blocked with a retarding DC voltage offset DC1.

The UVPD cell 108 could be replaced by a dead-end plate and branch 12₃ could be used for storing ions (e.g. for subsequent BoxCar acquisition such as described in WO 2018/134346 or subsequent multiplexed SIM as described in U.S. Pat. No. 7,880,136).

Alternatively, the CID cell 106 may be positioned behind branch 12₂ on the way to the TOF mass analyzer 112, as shown in the mass spectrometer 100b of FIG. 9. This architecture allows optional fragmentation of ions following their UVPD or ExD processing and before the mass-analysis. To this end, the ions are transferred from branch 12₃ or 12₄ to branch 12₂ to CID cell 106. To enable MS3 analysis (CID-CID, UVPD-CID, or ExD-CID), an ion gate 114 and an ion storage device 116 (e.g. a storage multipole) are introduced between the ion source 102 and the ion routing device 10. In operation, ions from the ion source 102 proceed through the open gate 114 and the ion storage device 116 without accumulation, are mass-selected in mass filter 104, and are transferred by the ion routing device 10 to one of the following ion processing devices; CID cell 106, UVPD cell 108, or ExD cell 110. Upon processing with a corresponding fragmentation method, the ions are driven back to the ion routing device 10 and directed to branch 12₁ to enter the mass filter 104 again. During this stage, the lon gate 114 is closed to prevent mixing of processed and unprocessed ions. On the way through the mass filter 104, the ions are mass-selected once more to select an ionic species of interest, which is accumulated in the ion storage device 116. At the next stage, the accumulated ions are marshalled back through the mass filter 104, the ion routing device 10 and the CID cell 106 towards the TOF mass analyzer 112, with optional further fragmentation in the CID cell 106.

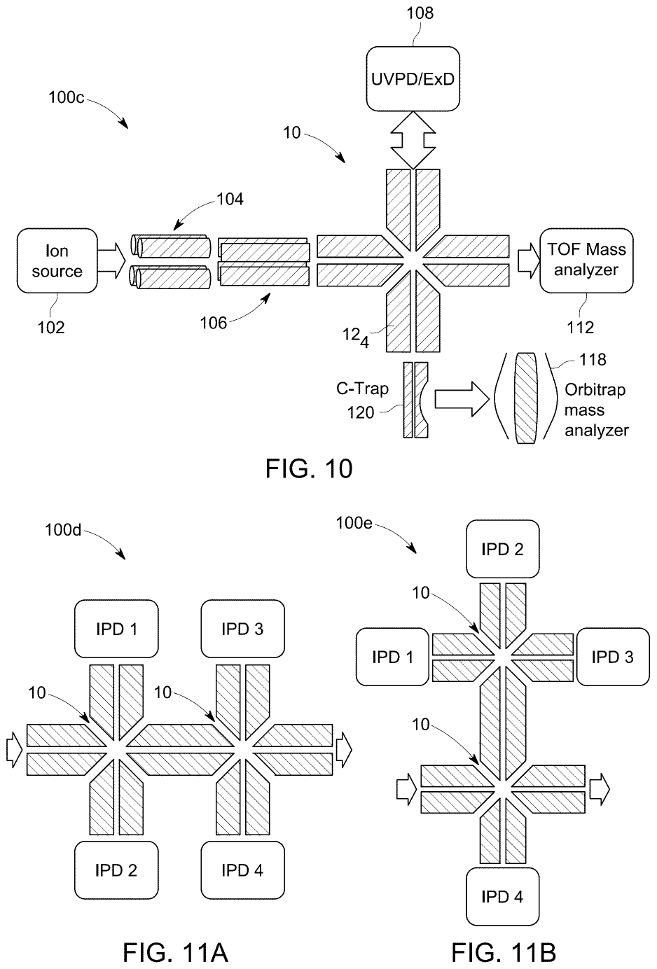

FIG. 10 shows a mass spectrometer 100c with two mass analyzers: a TOF mass analyzer 112 and an Orbitrap mass analyzer 118. Branch 12₄ of the ion routing device 10 may be used to divert some ions (fragmented or intact) into a C-shaped ion trap 120 (C-trap) from which the ions are orthogonally accelerated towards the Orbitrap mass analyzer 118. A mass spectrometer 100c of this architecture benefits from the high repetition rate of the TOF mass analyzer 112 and the high resolving power of the Orbitrap analyzer 118.

FIGS. 11A and 11B give examples of mass spectrometer architectures 100d and 100e with two ion routing devices 10 and multiple ion processing devices. The multiple ion routing devices 10 are preferably fabricated on the same pair of top and bottom PCBs 30 and share one gas supply capillary. The RF waveforms RF of the ion routing devices 10 have preferably the same frequency and are phase-synchronized to enable apertureless and lossless ion transfer between the ion routing devices 10. Various configurations of several ion routing devices 10 are illustrated by, but not limited to, those presented in FIGS. 11A and 11B.
A person skilled in the art will appreciate that the above embodiments may be varied in many different respects without departing from the scope of the present invention that is defined by the appended claims.

For example, the figures and description above relate to ion routing devices 10 where all branches 12₁ to 12₄ lie in a plane. However, this need not be the case. One or more branches 12₁ to 12₄ may lie out of plane. This may be used to allow additional branches 12₁ to 12₄. For example, two further branches 12₁ to 12₄ may be added that are 90° out of plane such that a six-branch cross may be realised. Also, where branches 12₁ to 12₄ are arranged in-plane, they need not extend at 90° to each other. For example, an in-plane six branch arrangement may be implemented where the branches 12₁ to 12₆ are equally spaced at 60° intervals.

1. An ion routing device comprising:
at least three branches that meet at a junction, wherein:
each branch defines an ion path through the ion routing device, the ion path through each branch defining a longitudinal axis of the branch,
each branch comprises longitudinally-extending electrodes, and
the longitudinally-extending electrodes of each branch are electrically isolated from the longitudinally-extending electrodes of adjacent branches; and
a controller configured to control passage of ions through the ion routing device, wherein the controller is configured to provide a RF electrical signal to the longitudinally-extending electrodes of each branch and to apply a DC bias to each RF electrical signal that differs between the longitudinally-extending electrodes of at least two of the adjacent branches.

2. The ion routing device of claim 1, wherein the controller is configured to provide a first set of in-phase RF electrical signals to a first set of the longitudinally-extending electrodes of the branches and a second set of in-phase RF electrical signals to a second set of the longitudinally-extending electrodes of the branches, wherein the second set of in-phase RF electrical signals is 180 degrees out of phase with the first set of in-phase RF electrical signals, such that electrical fields generated in each branch are in-phase with each other.

3. The ion routing device of claim 1, wherein the controller is configured to control the passage of ions through the ion routing device from an input branch to an output branch of the at least three branches, thereby leaving at least one unused branch, by:
providing the RF electrical signal to the longitudinally-extending electrodes of the input branch with a first DC bias,
providing the RF electrical signal to the longitudinally-extending electrodes of the output branch with a second DC bias that is lower in magnitude than the first DC bias, and
providing the RF electrical signal to the longitudinally-extending electrodes of the at least one unused branch with a third DC bias that is higher in magnitude than the first DC bias.

4. The ion routing device of claim 3, comprising a RF power supply for providing the RF electrical signal, and wherein either:
the RF power supply is configured to provide the RF electrical signal to the primary coil of a transformer that further comprises a secondary coil for each of the at least three branches;
the ends of each secondary coil are connected to at least one opposed pair of longitudinally-extending electrodes of the respective branch; and
the centre point of each secondary coil is connected to a DC power supply configured to provide the DC bias to the RF electrical signal;
or
the RF power supply is configured to provide the RF electrical signal to the primary coil of a transformer that further comprises a pair of secondary coils for each of the at least three branches; and
an end of each secondary coil of each pair is connected to one longitudinally-extending electrode of at least one opposed pair of longitudinally-extending electrodes of the respective branch, and the other end of the secondary coil of each pair is configured to be provided with a DC bias, one secondary coil receiving a DC bias equal to a DC voltage plus a DC resolving component and the other secondary coil receiving a DC bias equal to the DC voltage minus the DC resolving component.

5. The ion routing device of claim 1, further comprising a pair of central electrodes positioned on opposite sides of the junction and the controller is further configured to provide a DC electrical signal to the pair of central electrodes.

6. The ion routing device of claim 1, wherein each branch comprises four longitudinally-extending electrodes arranged to form two pairs of longitudinally-extending electrodes, each pair of longitudinally-extending electrodes positioned on opposite sides of the ion path thereby forming an opposed pair of the at least one opposed pair of longitudinally-extending electrodes.

7. The ion routing device of claim 1, wherein the at least three branches meet at the junction such that the size of the ion paths through each branch are maintained and, optionally, the ion paths extend through the junction without optical apertures configured to restrict the size of an ion beam travelling along the ion paths from one branch to another branch.

8. The ion routing device of claim 1, wherein:
the ends of the longitudinally-extending electrodes of adjacent branches that meet at the junction are shaped to form a mitred corner.

9. The ion routing device of claim 1, wherein:
the ends of the longitudinally-extending electrodes of adjacent branches are shaped so as to meet at the junction to form cut-out sections between the adjacent branches; and, optionally,
the cut-out sections form narrowed sections of the longitudinally-extending electrodes at the junction.

10. The ion routing device of claim 1, wherein:
each branch further comprises transversely-extending electrodes, and
the controller is further configured to provide a DC electrical signal to the transversely-extending electrodes of each branch.

11. The ion routing device of claim 10 wherein, for each branch, the controller is further configured to provide the DC electrical signal via a resistor chain such that the transversely-extending electrodes are provided with an electrical signal of varying DC magnitude.

12. The ion routing device of claim 11 wherein, for each branch:
the transversely-extending electrodes form a longitudinally-extending series of electrodes,
the resistor chain is configured such that the DC magnitude of the DC electrical signal provided to each transversely-extending electrode varies progressively along the series of electrodes; and, optionally,
the resistor chain is configured such that the DC magnitude of the DC electrical signal provided to each transversely-extending electrode varies linearly along the series of electrodes.

13. The ion routing device of claim 1, wherein the controller is further configured to apply traveling-wave voltage signals to the electrodes, optionally to apply dynamic or variable DC voltages, amplitude-modulated RF waveforms, or frequency-modulated RF waveforms in sequence to the electrodes.

14. The ion routing device of claim 10, wherein:
the longitudinally-extending electrodes and the transversely-extending electrodes are formed on printed circuit boards and, optionally,
the longitudinally-extending electrodes are attached to the printed circuit boards, and the transversely-extending electrodes are formed directly on the printed circuit boards, for example by etching.

15. The ion routing device of claim 14 when dependent upon claim 11, wherein the outer sides of the printed circuit boards are provided with electrical contacts, that connect to the longitudinally-extending electrodes and the transversely-extending electrodes, and the resistor chain.

16. A method of selectively directing ions through an ion routing device, wherein the ion routing device comprises at least three branches that meet at a junction, with each branch defining an ion path through the ion routing device with the ion path through each branch defining a longitudinal axis of the branch, with each branch comprising longitudinally-extending electrodes, and with the longitudinally-extending electrodes of each branch being electrically isolated from the longitudinally-extending electrodes of adjacent branches, the method comprising:
providing a RF electrical signal to each of the longitudinally-extending electrodes of each branch; and
applying a DC bias to each RF electrical signal that differs between the longitudinally-extending electrodes of at least two of the adjacent branches.

17. The method of claim 16, comprising providing a first set of in-phase RF electrical signals to a first set of the longitudinally-extending electrodes of the branches and a second set of in-phase RF electrical signals to a second set of the longitudinally-extending electrodes of the branches, wherein the second set of in-phase RF electrical signals is 180 degrees out of phase with the first set of in-phase RF electrical signals such that electrical fields generated in each branch are in-phase with each other.

18. The method of claim 16, comprising selectively directing ions through the ion routing device from an input branch to an output branch of the at least three branches, thereby leaving at least one unused branch, by:
providing the RF electrical signal to the longitudinally-extending electrodes of the input branch with a first DC bias,
providing the RF electrical signal to the longitudinally-extending electrodes of the output branch with a second DC bias that is lower in magnitude than the first DC bias, and
providing the RF electrical signal to the longitudinally-extending electrodes of the at least one unused branch with a third DC bias that is higher in magnitude than the first DC bias.

19. The method of claim 18, comprising either:
using a RF power supply to provide the RF electrical signal to the primary coil of a transformer that further comprises a secondary coil for each of the at least three branches, wherein the ends of each secondary coil are connected to at least one opposed pair of longitudinally-extending electrodes of the respective branch, and the centre point of each secondary coil is connected to a DC power supply configured to provide the DC bias to the RF electrical signal;
or
using a RF power supply to provide the RF electrical signal to the primary coil of a transformer that further comprises a pair of secondary coils for each of the at least three branches, wherein an end of each secondary coil of each pair is connected to one longitudinally-extending electrode of at least one opposed pair of longitudinally-extending electrodes of the respective branch, and the other end of the secondary coil of each pair is provided with a DC bias, one secondary coil receiving a DC bias equal to a DC voltage plus a DC resolving component and the other secondary coil receiving a DC bias equal to the DC voltage minus the DC resolving component.

20. The method of claim 16, further comprising providing a DC electrical signal to a pair of central electrodes positioned on opposite sides of the junction.

21. The method of claim 16, wherein each branch further comprises transversely-extending electrodes, and the method further comprises providing a DC electrical signal to the transversely-extending electrodes of each branch.

22. The method of claim 21 comprising, for each branch, providing the DC electrical signal via a resistor chain such that the transversely-extending electrodes are provided with an electrical signal of varying DC magnitude.

23. The method of claim 22 wherein, for each branch, the transversely-extending electrodes form a longitudinally-extending series of electrodes such that the DC magnitude of the DC electrical signal provided to each transversely-extending electrode varies progressively along the series of electrodes.

24. The method of claim 23 wherein, for each branch, the resistor chain is configured such that the DC magnitude of the DC electrical signal provided to each transversely-extending electrode varies linearly along the series of electrodes.

25. The method of claim 16, further comprising applying traveling-wave voltage signals to the electrodes, optionally applying dynamic or variable DC voltages, amplitude-modulated RF waveforms, or frequency-modulated RF waveforms in sequence to electrodes.
